(19) United States
(12) Patent Application Publication
(10) Pub. No.: US 2006/0059327 A1
(43) Pub. Date: Mar. 16, 2006

(54) Method to reset an image to a known state

(76) Inventors: Norman P. Brown, Tomball, TX (US); Sam Jung-Won Lee, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/939,939

(22) Filed: Sep. 13, 2004

(51) Int. Cl. G06F 15/177

(52) U.S. Cl. 713/1

(57) ABSTRACT

A method and apparatus for resetting an image to a known state are provided. The method comprises autonomously deleting a plurality of first registry files associated with a current state and a non-proprietary file system; loading a kernel associated with a known state; and restoring a plurality of second registry files associated with the kernel.

### BACKGROUND

A thin client refers to a device or software that requests applications and/or files from another computing device, such as a server, for example. A thin client device is typically a processor-based device that is equipped with minimal hardware and software, hence the term “thin.” At a minimum, a thin client is loaded with an operating system (OS) such as WINDOWS™ CE that provides configuration settings that the thin client uses to work in a specific system. Loading a thin client with WINDOWS™ CE entails building a default registry that represents a default configuration. The default registry typically includes the configuration settings for the thin client. For example, the settings include display settings, network settings, computer name, Internet Protocol (IP) address, Instant Messaging (IM) settings, passwords, permission settings, and dial-up settings, among others. Typically, the default registry is part of a default image that includes all the files and data the thin client uses when it is first set up. For example, an image may include files, data, driver, and/or programs that a thin client uses to operate in a specific fashion. To illustrate the preceding, the image may contain the driver for a specific printer device.

Depending on how the default registry is configured, when the thin client is first booted-up, the OS makes a copy of the default registry on the local hard drive. Thereafter, the thin client uses the locally stored registry (local registry) to boot-up and the configuration set by the local registry determines how the thin client works in the system. As the needs of the user of a thin client change, the registry can be updated to reflect changes in the configuration. These changes may be performed at the image level, or may be performed at the registry. Typically, when the configuration is changed at the thin client, the local registry is updated, while the default image used to set up the thin client retains default settings. In effect, the thin client may be operating with an updated configuration or image, while the default registry and/or the default image include the default configuration. Thus, the updated local registry may be part of an image that has a more current version than the default registry and/or default image.

A problem with maintaining the local registry is that the OS does not verify that the updated configuration is one the OS can support. In some instances, the updated configuration becomes corrupted or may be updated with changes that the OS cannot establish. As an example, the OS may not support a display resolution that the user has requested through the change of the display settings. Thus, the OS may fail to display properly on the screen of the thin client and/or may fail to boot-up. The technique to maintain the local registry is to restore the default registry that, even though not the most current version, is known to restore the thin. client to an operational status. Users can not delete the registry files from within the OS because these files are protected by the OS.

To alleviate this and some other problems, some manufacturers have opted to use a closed architecture where users do not have access to a file structure and thus cannot delete configuration files on their own. A closed architecture typically involves a proprietary file system that cannot by definition be accessed by a user to restore the default registry in this fashion. The user only has access to a user interface, thus, removing files, updating an image, or even restoring a thin client may involve having the manufacturer of the closed OS to solve the problem. It is desirable to use an open PC architecture, such as that provided with WINDOWS™ CE. This type of open access enables third-party software developers to create and load customized images for different applications. Customizing images and/or restoring the current image to the default in a secure and effective way, however, has posed problems for both open and closed architectures.

### SUMMARY

According to at least one embodiment, a method for resetting an image to a known state comprises autonomously deleting a plurality of first registry files associated with a current state and a non-proprietary file system; loading a kernel associated with a known state; and restoring a plurality of second registry files associated with the kernel.

According to another embodiment, computer-executable software code for restoring an image at a thin client comprises a boot loader external to the operating system of the thin client, the boot loader operable to restore the image to a known state.

According to yet another embodiment, a boot loader comprises means for detecting a predetermined stimulus; means for autonomously deleting a plurality of registry files associated with a current state and a non-proprietary file system; and means for restoring an image to a known state.

According to yet another embodiment, a system comprises an operating system image compatible with a non-proprietary file system, wherein said operating system image includes a registry with default configuration information; and a boot loader operable to reset said system to said default configuration information.

According to yet another embodiment, a thin client comprises non-volatile memory storing an operating system image that is compatible with a non-proprietary file system, wherein said operating system image includes a registry with default configuration information; data storage storing user-modifiable configuration information; and a boot loader operable to determine whether to reset said user-modifiable configuration information to said default configuration information.

According to yet another embodiment, a method for resetting an image to a known state comprises storing an operating system image that is compatible with a non-proprietary file system to non-volatile storage of a thin client, wherein said operating system image includes a registry with default configuration information; storing user-modifiable configuration information on said thin client; and determining, by a boot loader of said thin client, whether to reset said user-modifiable configuration information to said default configuration information.

### BRIEF DESCRIPTION OF THE DRAWINGS

FIG. 1 is a diagram of one embodiment of system that may be used to reset an image to a known state;

FIG. 2 is a diagram of one embodiment of a method for resetting an image to a known state;

FIG. 3 is a diagram of one embodiment of a system that may be used to reset an image to a known state;

FIG. 4 is a diagram of another embodiment of a method for resetting an image to a known state; and

FIG. 5 is a diagram of yet another embodiment of a method for resetting an image to a known state.

### DETAILED DESCRIPTION

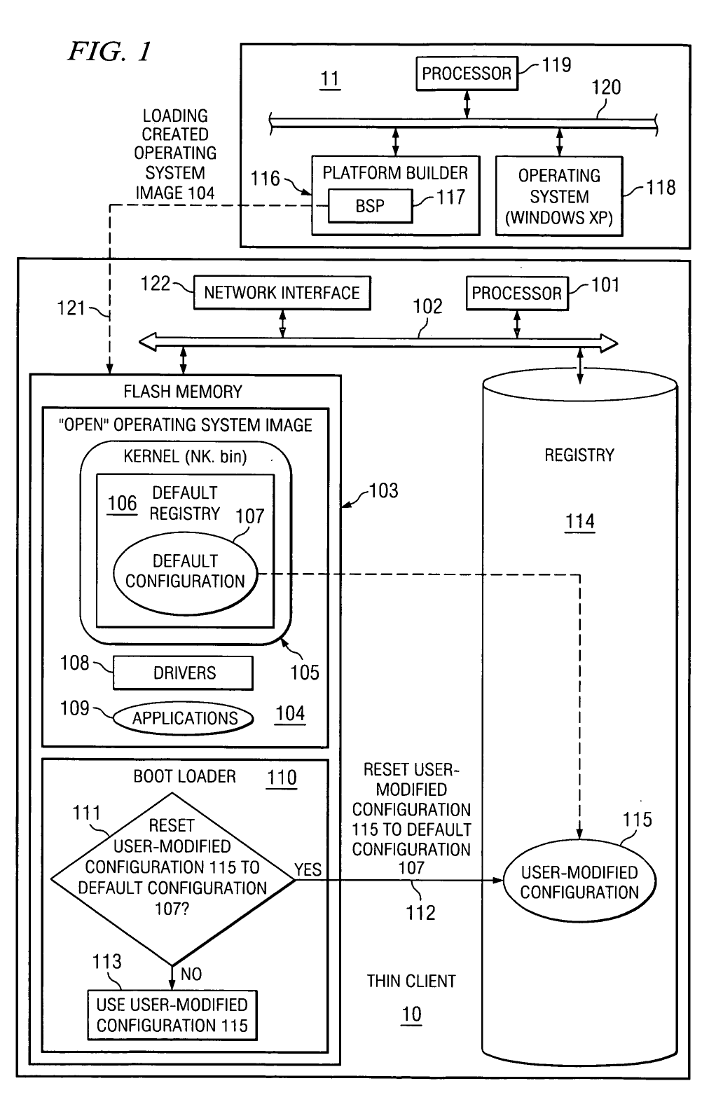

FIG. 1 is a diagram that illustrates one embodiment of a system for resetting a non-proprietary operating system, such as WINDOWS™ CE, to a known state. Generally speaking, some configurations of WINDOWS™ CE may be considered an open Personal Computer (PC) architecture. In one such configuration, a standard file tracking system such as File Allocation Table (FAT) standard, such as a FAT16, FAT32, or other suitable standard, is used to keep track of where the data is stored in a given PC. Such a standard file tracking system can be perused by anyone having access to the storage locations of the given PC. A flash device is a storage location that can also use the FAT standard. For example, an image for a thin client may be stored in a flash device such that anyone can access the files associated with the image using FAT. This may be useful because a flash device may be used to boot up the PC and a software developer can use a flash device to load images to the PC.

A closed (or “proprietary”) architecture does not use FAT and therefore files stored at the thin client cannot be accessed as easily as those of the open architectures. In fact, the point of a closed architecture is to limit access to the file structure and development of software programs by third parties, i.e. software developers, owners of the system, users, etc.; only the manufacturer has full file level access to the system. Providing a thin client software development tool in an open architecture is therefore desirable and advantageous for software developers that seek to customize images for thin clients. A specific image may be created for a particular user, or a group of users.

The system illustrated in FIG. 1 includes an image builder 11 and a thin client 10. In the illustrated embodiment, image builder 11 includes a processor 119, an operating system (OS) 118, and a platform builder 116 communicatively coupled as shown via a bus 120. In the present embodiment, OS 118 comprises a WINDOWS™ based operating system, such as WINDOWS™ XP, which makes image builder 11 an open architecture PC. Platform Builder 116 is an application provided to build an operating platform for a given thin client. For example, image builder 11 may comprise a PC loaded with WINDOWS™ XP that a software developer may use to create a specific image, via platform builder 116, that a thin client, such as thin client 10, uses to load up specific applications and drivers.

Platform Builder 116 includes a Board Support Package (BSP) 117 that allows a software developer to develop customized images for thin clients, such as thin client 10. BSP 117 supports an emulator that can access a library where components, drivers, accessories, and files are accessible to the software developer. The emulator may display the options available and may show the selected components that will become part of the image being built. For example, the software developer may access, using an emulator of BSP 117, the library for the drivers that are available for a variety of thin clients, such as audio drivers, display driers, input device drivers, etc., and the software developer may build a catalog comprising the drivers selected for the specific thin client being configured. BSP 117 is also operable to create an “open” OS image file that includes a kernel, such as an NK.bin file, as an example. NK.bin is a known type of kernel file commonly used in WINDOWS™ CE.

Thin client 10 comprises a flash memory 103, a local registry 114, a network interface 122, and a processor 101 communicatively coupled via a bus 102. Flash memory 103 comprises an “open” OS Image 104 and a boot loader 110 that enable thin client 10 to store local registry 114 and to reset local registry 114 to a known state, as described further herein. The “open” OS image file created by BSP 117 is essentially “open” OS image 104, which may be loaded onto thin client 10 using flash memory 103, for example. While flash memory 103 is used in this example, other types of non-volatile memory may be used in other embodiments, including without limitation Read Only Memory (ROM), Random Access Memory (RAM), Programmable Read-Only-Memory (PROM), and Erasable Programmable Read-Only-Memory (EPROM), The term “open” is used in this document to describe the use of a non-proprietary file structure and/or operating system architecture.

The “open” OS image 104 (“image 104”) comprises a kernel 105, drivers 108, and applications 109 which make up a substantial majority of the components that thin client 10 needs to boot up in a specific configuration. In one embodiment, image 104 comprises a file that includes the components. The file may be substantially large in order to contain the components. For example, image 104 may comprise as much as 10 to 30 megabytes of data. Image 104, however, does not have to comprise all the needed components and may not comprise a distinct file. That is, some drivers 108 and/or applications 109, not part of image 104 may be loaded directly to other local storage of thin client 10. Additionally, image 104 may comprise a cluster of files or data not necessarily compiled into one data structure such as a file.

Kernel 105 comprises OS components and a default registry 106 that stores the default configuration 107 of thin client 10. Some of the OS components that may be included in kernel 105 are Application Program Interfaces (APIs). According to the illustrated embodiment, kernel 105 comprises the NK.bin file. A registry may be described as a set of parameters that define the status of drivers and applications that are installed on a processor-based device. For example, default registry 106 may comprise a configuration file. In other embodiments, default registry 106 comprises a database. As used in this document, “default” describes preset factory settings that are configured for the processor-based device. In the present example, default registry 106 includes default configuration 107, which may including the default settings and parameters that drivers and applications use to load up for the first time. It is precisely this default registry 106 that is stored locally, to local registry 114, at thin client 10 when thin client 10 boots up for the first time. Default registry 106 does not change its parameters or settings even when the settings of thin client 10 are updated. As will be described shortly, local registry 114 keeps track of updates at thin client 10, while default registry 106 remains what its name aptly describes, the default.

When thin client 10 boots up for the first time, the default configuration 107 is replicated at local registry 114 as user-modified configuration 115. The “open” OS of thin client 10 uses local registry 114 to update the configuration of thin client 10. For example, if a display setting is changed, the default registry 106 remains the same and the user-modified configuration 115 of local registry 114 is updated to reflect the new display setting. According to the illustrated embodiment, local registry 114 is stored at a local hard drive, but it may instead be stored to other non-volatile memory. According to another embodiment, local registry 114 is stored at flash memory 103.

During the first boot up, drivers 108 and applications 109 may also be loaded and stored at a local hard drive. According to one embodiment, drivers 108 include the drivers that thin client 10 uses to communicate with peripherals, hardware, and/or software. According to another embodiment, applications 109 include add-ons such as Remote Desktop Protocol (RDP) software, Internet Explorer software, CITRIX software, and networking software, as examples. “Add-ons” may be described as software, applications, or other data that is added to the kernel components and operating systems. Drivers 108 and applications 109 are registered with default registry 106 in order to keep track of which drivers 108 and applications 109 are to be used at thin client 10. Keeping the status of what drivers 108 and applications 109 are to be used at thin client 10 results in having a default registry 106 that describes a known state, i.e. the default state.

According to the illustrated embodiment the NK.bin file includes operating system and kernel components. This file can be customized in order to include the components needed for a specific configuration. The BSP 117 and Platform Builder 116 allow customization of the NK.bin file by virtue of having an “open” OS architecture that supports the FAT16, FAT32, or other suitable file standard, without having end-users contact the original equipment manufacturer (OEM) for services. Customizing the NK.bin file may be known as customizing the “image” for thin client 10. To add or subtract functionality or to update components, a system developer searches through the files stored at the local storage of thin client 10 for the NK.bin file and associated components, and replaces the previous image, i.e. “old” NK.bin file, with the new image, i.e. “new” NK.bin file.

Boot loader 110 is a process that resides in the boot sector of the primary storage, and, during boot up of thin client 10, loads the NK.bin kernel into memory. In some embodiments boot loader 110 may be located in other storage locations of thin client 10. For example, boot loader 110 may be called up during power on self-test, which looks to a flash device for boot loader support. In embodiments referring to WINDOWS™ CE, boot loader 110 is executed during the boot-up process that occurs after pressing the “Start” button on thin client 10. According to one embodiment, boot loader 110 loads the NK.bin file into extended memory as an OS process, which begins executing the NK.bin file. The NK.bin file initializes and brings up the rest of the OS.

During this boot up process, boot loader 110 determines, in operational block 111, whether to reset the user-modified configuration 115 to default configuration 107. If the user-modified configuration 115 is to be reset in this manner, boot loader 110 resets user-modified configuration 115 in operation 112, and in either case, boot loader 110 proceeds to load the OS, which uses user-modified configuration 115 (which may have been reset to default configuration 107) of local registry 114. Operation 112 of operational block 111 is triggered by predefined stimuli. In one embodiment, boot loader 110 detects a flag file that triggers the reset of user-modified configuration 115 to default configuration 107.

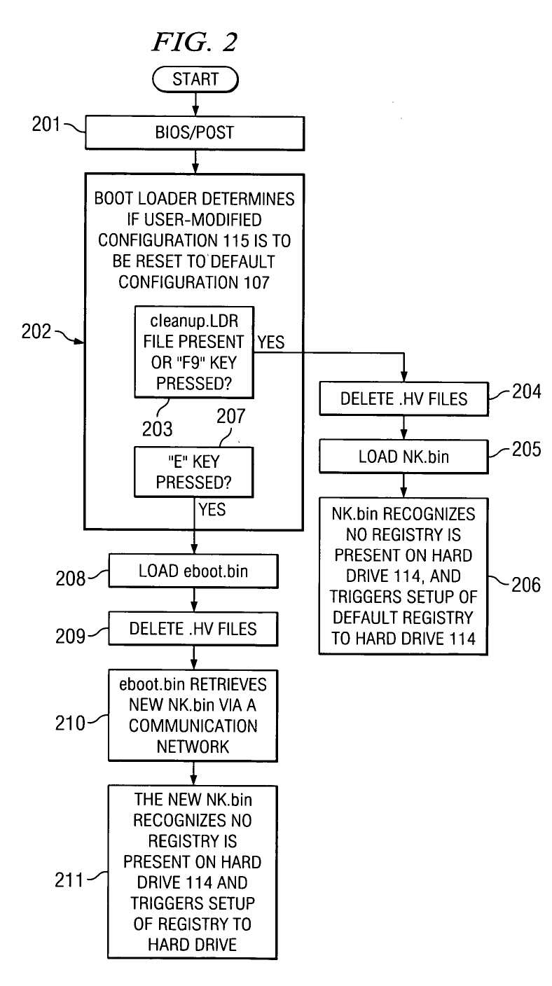

The flag file may be created prior to performing the boot loading routine of boot loader 110. For example, a user may create the flag file by requesting a reset prior to shutting down thin client 10. In one embodiment, the flag file is named “CleanUp.LDR” and is stored in the root of the hard drive, or flash memory device. The existence of the flag file acts as a signpost to the OS so that when the BIOS/Post process is executed (process 201 of FIG. 2) boot loader 110 is alerted that user-modified configuration 115 is to be replaced with default configuration 107. Other predefined stimuli that may be used to trigger operation 112 comprises detection of a key press as will be described with more particularity in FIG. 2. Any other suitable predefined stimuli may be used. For example, boot loader 110 may be commanded to reset.

Boot loader 110 deletes the files associated with the user-modified configuration 115 in order to reset local registry 114 to the default state. According to one embodiment, WINDOWS™ CE OS uses the file denomination “.HV” to identify support files that are associated with the installed configuration. For example, a file may be named “standard.hv,” which may be a driver file corresponding to a standard piece of hardware installed at thin client 10. Boot loader 110 identifies the location of “system.hv” and “user.hv” files, sometimes referred to in the industry as “hives,” and deletes them. Boot loader 110 deletes the “hives” and the NK.bin file corresponding to the user-modified configuration 115 so that user-modified configuration 115 can be reset to default configuration 107. When the default NK.bin file is executed, an OS feature looks for the “hives”, and since these have been deleted, it rebuilds local registry 114 using default configuration 107. The result is a user-modified configuration 115 that mirrors default configuration 107.

In certain embodiments, boot loader 110 resets the user-modified configuration 115 by detecting a specific key press to trigger deleting the registry files, i.e. the “hives”, and restoring the default configuration 107. In other embodiments, the OS may detect a problematic condition setting, i.e. the predetermined stimuli, and trigger the reset of the configuration settings, e.g. by creating the flag file. According to one embodiment, boot loader 110 detects if a specific key, such as “F9,” is pressed during the boot-up process. Any other suitable key or sequence of keys may be used. If the specific key is pressed, boot loader 110 resets the user-modified configuration 115 by deleting the corresponding NK.bin file and the associated “hives” and restoring the default configuration 107 as already explained. Restoring local registry 114 to default, or known, state is advantageous because system developers can customize images for thin clients with the added functionality of resetting the image to a default image if the current image becomes corrupted or if the image becomes an outdated, “old”, version of the image desired for thin client 10. Additionally, because the boot loader 110 is equipped with location information of where the “hives” are located in the storage devices, the process for deleting the “hives” is automatic. Therefore, a system that restores local registry 114 to a default state in this fashion may be more user friendly and may improve the efficiency of developing images for thin clients because the system developer does not have to worry about keeping track of where the registry file or “hives” are located.

Although boot loader 110 has been described with reference to a thin client operating in a WINDOWS™ CE environment, boot loader 110 may be modified to operate in any other suitable environment. For example, boot loader 110 may be used with Linux based system. In that embodiment, a Linux based desktop system may use “.config” files for the configuration files. The original factory configuration files may be kept in a different location and copied to the location where the current configuration files are located to reset the factory default settings. Additionally boot loader 110 is described as a module that may be embodied in software, code, instructions, or any other suitable logic.

Referring now to FIG. 2, an operational flowchart of one embodiment for resetting an image to a known state is illustrated. Generally, thin client 10 boots up when the device is powered on and when the device is being restarted. The process of booting up triggers the loading of a BIOS process that begins at step 201 and comprises executing the booting up procedures. In the illustrated embodiment, the BIOS step 201 proceeds to call up boot loader 110. At step 202 boot loader 110 determines if user-modified configuration 115 is to be reset to default configuration 107.

As previously described, boot loader 110 detects if a flag file or specific key is pressed in order to reset local registry 114. At step 203, the boot loader 110 detects if either of these conditions is present. If either of these conditions is present, boot loader 110 continues to step 204, where the “hive” files are deleted. After deleting the “hive” files, boot loader 110 loads the default kernel file, i.e. NK.bin file, from the local OS, i.e. the OS loaded at the thin client 10. At step 206, the kernel file, NK.bin, recognizes that local registry 114 is not located at the hard drive and triggers setup of the default registry 106 to the local storage, i.e. hard drive by repopulating the “hives” corresponding to the default configuration 107, as in the case of an initial boot up of the system.

Returning now to step 202, where the boot loader 110 determines if the registry is to be reset, boot loader 110 also detects if another specific key, for example the “E” key, is pressed. If the “E” key is detected as being pressed, boot loader 110 runs a routine, which may be referred to as an “eboot” routine, where the OS kernel is loaded from a remote location. As used in this document, remote location refers to locations outside of the local OS. For example, boot loader 110 may initiate the loading of a kernel at thin client 10 from a server. Although the “E” key is used to exemplify the triggering of an “eboot” routine, it is understood that any other key, or combination of keys, may be used to trigger the “eboot” routine.

At step 208, boot loader 110 loads the “eboot.bin” file that performs the boot-up routine for loading the kernel, NK.bin, from the remote location. In the present embodiment, “eboot.bin” refers to a boot-up process through an Ethernet connection. Any other suitable file name may be used to refer to the remote kernel loading routine. Additionally, any other remote connection may be utilized to load the NK.bin file. For example, the remote boot-up may be performed through a serial, parallel port or ethernet connection. The “eboot.bin” file, in one embodiment, comprises a sub-routine that looks for the NK.bin file at a location outside of thin client 10, such as through a server, for example.

At step 209, the running “eboot” routine deletes the “hives” and at step 210 the “new” NK.bin file is loaded at thin client 10. The loaded NK.bin file searches for the associated “hives.” Since these “hives” were deleted in a previous step, the loaded NK.bin triggers the setup of a “new” local registry 114 at hard drive, where the “new” “hives” corresponding to the “new” configuration are restored. Having the boot loader 110 as an application outside of the OS structure, enables a system developer to access the boot loader 110 as an “open” architecture file in order to customize how the thin client 10 is boot up. In the present embodiment, boot loader 110 comprises a FAT16 structure, which is accessible by virtue of it being non-proprietary.

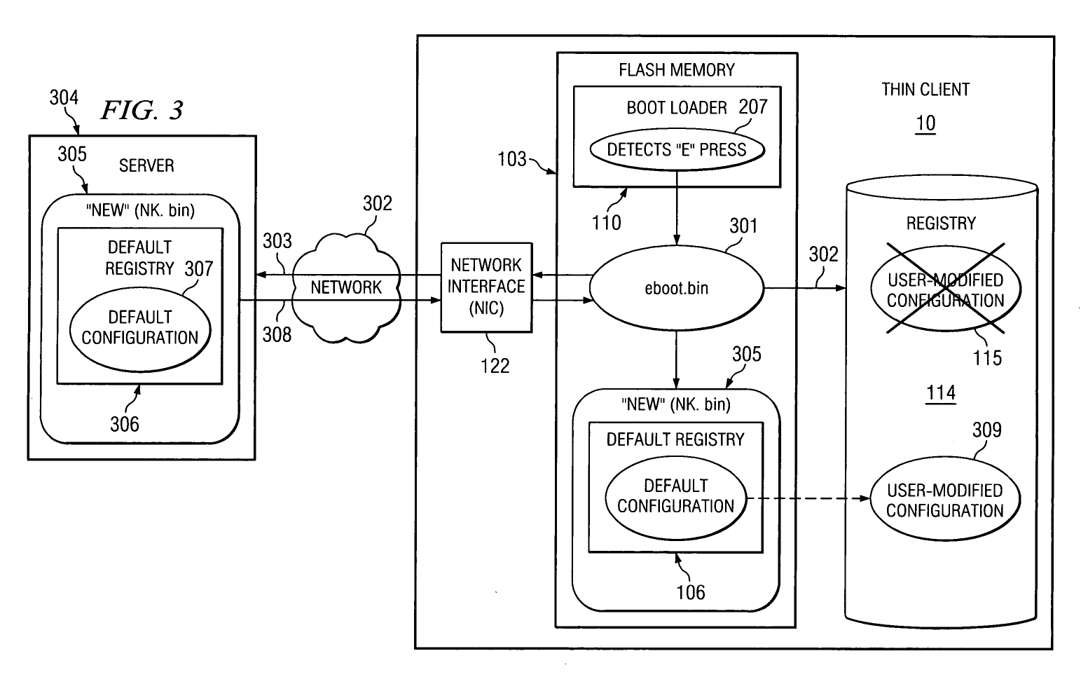

In FIG. 3, an example of a system for resetting an image to a default state in accordance with an “eboot” routine is illustrated. As was described with reference to the “eboot” routine, boot loader 110 is operable to access the kernel file at a system outside of the local thin client 10 OS. In the illustrated embodiment, thin client 10 accesses a server 304 via network 303. Thin client 10 is equipped with a network interface card 122 (NIC) that interfaces thin client 10 with server 304. Network 303 may be any suitable network, such as a private local area network, for example. Boot loader 110 resides at flash memory 103 and implements the process of detecting the pressing of the “E” key (process 207) during the boot-up routine of thin client 10. This detection triggers the loading of the “eboot.bin” (process 301) as was described with reference to FIG. 2. The NIC 122 sends data to the server 304 via uplink 303 and receives data from the server 304 using downlink 300. This bi-directional link may comprise any suitable two-way link, such as a DSL, TI, or any other suitable communication link.

The “eboot” routine causes user-modified configuration 115 to be deleted from the local hard drive. This step of the “eboot” routine is performed by deleting the “hives” from the hard drive or from any other storage device at thin client 10. As was previously described, deleting the “hives” causes restoring of the “hives” associated with the “new” kernel. Since the kernel looks for the registry files that it is associated with, restoring the default configuration 307 requires clearing the old registry files. This is performed also to prevent confusion by the new image, which may require different locations for each component that it loads and may need the registry to be updated to reflect the locations required by default configuration 307.

According to the illustrated embodiment, the “new” NK.bin file 305 sought to be restored at thin client 10 resides at server 304. This file is accessed by the “eboot.bin” routine and loaded up in order to establish the new image at thin client 10. The “new” NK.bin 305 is loaded at thin client 10 from server 304 and detecting that the there are no registry files available, it stores the new registry using default configuration 307. The illustrated embodiment shows that default configuration 307 becomes user-modified configuration 309.

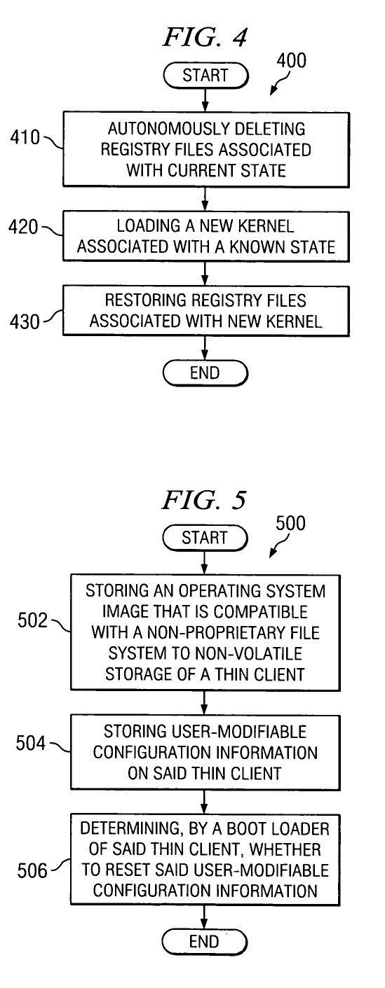

FIG. 4 illustrates an operational flowchart 400 of one embodiment for resetting an image to a known state. At step 410 the registry files associated with the current state are autonomously deleted. A new kernel associated with a known state is loaded at step 420. And, at step 430, the registry files associated with the new kernel are restored.

Referring now to FIG. 5, an embodiment of a method 500 for resetting an image to a known state is illustrated. At step 502, an operating system image that is compatible with a non-proprietary file system is stored to non-volatile storage of thin client 10. The operating system image includes registry 106 with default configuration information 107. A user-modifiable configuration information 115 is stored on thin client 10 at step 604. And, at step 606, boot loader 110 determines whether to reset the user-modifiable configuration information 115.

In summary, a boot loader 110 is provided to detect that a reset of the registry of thin client 10 is requested. In one embodiment, boot loader 110 automatically deletes registry files corresponding to the user-modified configuration 115 in response to a user indication that the default configuration is sought to be restored. The response from the user may be in the form of pressing an “F9” key or requesting the reset through an OS prompt that causes a flag file to be copied to the hard drive. The boot loader 10 deletes the “hives”, loads the “new” kernel, and restores the registry using the “new” “hives” corresponding to the new kernel. The boot loader 110 is a process outside of the OS that uses FAT16, FAT32, or any other “open” architecture file standard, such that the kernel file can be perused and modified. Such non-proprietary access to a boot-up procedure is highly desirable to system developers, who may create images with the added feature of an automatic restore that does not require contact with the OS manufacturer in order to execute. Additionally, the “eboot” routine makes it easier for a system developer to load the OS from a remote location.

What is claimed is:

1. A method for resetting an image to a known state comprising:
autonomously deleting a plurality of first registry files associated with a current state and a non-proprietary file system;
loading a kernel associated with a known state; and
restoring a plurality of second registry files associated with the kernel.

2. The method of claim 1 wherein autonomously deleting the plurality of first registry files is performed in response to a predetermined stimulus.

3. The method of claim 2 wherein the predetermined stimulus comprises the existence of a flag file.

4. The method of claim 2 wherein the predetermined stimulus comprises the detection of a key press.

5. The method of claim 4 wherein loading the kernel associated with a known state is performed by accessing the kernel at a remote location when the predetermined stimulus is associated with a remote reset routine.

6. The method of claim 1 further comprising executing a remote reset routine that restores the plurality of second registry files using the kernel accessed from a remote location.

7. The method of claim 1 wherein:
the current state comprises a user-modified configuration and the known state comprises a default state;
the plurality of first registry files comprises hive files associated with the user-modified configuration; and
the plurality of second registry files comprises hive files associated with the default state.

8. Computer-executable software code for restoring an image at a thin client comprising a boot loader external to the operating system of the thin client, the boot loader operable to restore the image to a known state.

9. The software of claim 8 wherein the known state comprises a default state.

10. The software of claim 8 wherein the boot loader is further operable to be accessed using an open file structure.

11. The software of claim 10 wherein the open file structure comprises a File Allocation Table (FAT) structure.

12. The software of claim 8 wherein the boot loader is further operable to track the location of a plurality of registry files associated with the image.

13. The software of claim 8 wherein the boot loader is further operable to call a routine that initiates the loading of a kernel file associated with the image.

14. A boot loader comprising:
means for detecting a predetermined stimulus;
means for autonomously deleting a plurality of registry files associated with a current state and a non-proprietary file system; and
means for restoring an image to a known state.

15. The boot loader of claim 14, wherein the predetermined stimulus comprises the existence of a flag file.

16. The boot loader of claim 14, wherein the predetermined stimulus comprises the detection of a key press.

17. The boot loader of claim 14, wherein the boot loader further comprises means for loading the kernel associated with a known state, where the means for loading accesses the kernel associated with the known state at a remote location when the predetermined stimulus is associated with a remote reset routine.

18. The boot loader of claim 17, wherein the remote reset routine comprises detecting a key press that triggers loading of a reset routing that is accessed through an Ethernet connection.

19. The boot loader of claim 14, wherein:
the current state comprises a user-modified configuration and the known state comprises a default state;
the plurality of registry files comprises hive files associated with the user-modified configuration; and
the means for restoring the image to the known state access a second plurality of registry files comprising hive files associated with the default state.

20. A system comprising:
an operating system image compatible with a non-proprietary file system, wherein said operating system image includes a registry with default configuration information; and
a boot loader operable to reset said system to said default configuration information.

21. The system of claim 20, further comprising:
non-volatile storage means for storing the open operating system image that includes the default configuration information defined therein;
means for storing user-modifiable configuration information; and
means, external to said operating system image, for resetting said user-modifiable configuration information to said default configuration information.

22. A thin client comprising:
non-volatile memory storing an operating system image that is compatible with a non-proprietary file system, wherein said operating system image includes a registry with default configuration information;
data storage storing user-modifiable configuration information; and
a boot loader operable to determine whether to reset said user-modifiable configuration information to said default configuration information.

23. A method comprising:
storing an operating system image that is compatible with a non-proprietary file system to non-volatile storage of a thin client, wherein said operating system image includes a registry with default configuration information;
storing user-modifiable configuration information on said thin client; and
determining, by a boot loader of said thin client, whether to reset said user-modifiable configuration information to said default configuration information.
